(19) United States
(12) Patent Application Publication
(10) Pub. No.: US 2017/0130732 A1
(43) Pub. Date: May 11, 2017

(54) COMPRESSOR EXIT SEAL

(71) Applicant: UNITED TECHNOLOGIES CORPORATION, Hartford, CT (US)

(72) Inventors: Frederick M. Schwarz, Glastonbury, CT (US); Jorn A. Glahn, Manchester, CT (US)

(21) Appl. No.: 14/934,303

(22) Filed: Nov. 6, 2015

(51) Int. Cl. F04D 29/08; F04D 29/58; F04D 29/52; F04D 29/32; F04D 29/54

(52) U.S. Cl. CPC F04D 29/083; F04D 29/324; F04D 29/542; F04D 29/522; F04D 29/582; F05D 2220/32

(57) ABSTRACT

A gas turbine engine compressor section has a hub carrying a last row of compressor blades. A compressor exit guide vane is downstream of the last row of compressor blades. A housing is radially inward of the compressor exit guide vane. A non-contact seal is positioned on one of the housing and the hub.

### BACKGROUND OF THE INVENTION

This application relates to a sealing arrangement wherein a non-contact seal is placed between a rotor hub and a compressor exit guide vane.

Gas turbine engines are known and typically include a fan delivering air into a compressor and into a bypass duct. The air is compressed in the compressor and delivered into a combustion section where it is mixed with fuel and ignited. Products of this combustion pass downstream over turbine rotors driving them to rotate.

There are many challenges with the compressor design. One challenge is to increase the pressure and temperature of the air leaving the last stage of the compressor. However, a hub which rotates with compressor blades experiences stresses as this temperature increases.

### SUMMARY OF THE INVENTION

In a featured embodiment, a gas turbine engine compressor section has a hub carrying a last row of compressor blades. A compressor exit guide vane is downstream of the last row of compressor blades. A housing is radially inward of the compressor exit guide vane. A non-contact seal is positioned on one of the housing and the hub.

In another embodiment according to the previous embodiment, a sacrificial piece is located on the other of the housing and the hub.

In another embodiment according to any of the previous embodiments, the sacrificial piece is removable from the one of the housing and the hub.

In another embodiment according to any of the previous embodiments, the non-contact seal is mounted on the housing and seals on a radially outer surface of the sacrificial piece.

In another embodiment according to any of the previous embodiments, the non-contact seal has a plurality of circumferentially spaced shoes biased radially toward the sacrificial piece.

In another embodiment according to any of the previous embodiments, the air feed holes are included to tap air from a radially mid span of the compressor section through the housing, and to pass along the hub to resist flow of air radially inward of a gap between the last row of compressor blades and the housing from a radially inner, hotter location along the compressor blades.

In another embodiment according to any of the previous embodiments, the tapped air is tapped through the compressor exit guide vane.

In another embodiment according to any of the previous embodiments, at least some of the air feed holes are tapped from an upstream end of compressor exit guide vane.

In another embodiment according to any of the previous embodiments, at least some of the air feed holes are tapped from a downstream end of the compressor exit guide vane.

In another embodiment according to any of the previous embodiments, the tapped air also passes through a controlled leakage path between the non-contact seal and the sacrificial piece to pass into a chamber downstream and towards a turbine section.

In another embodiment according to any of the previous embodiments, there is a ditch in the hub downstream of the last row of compressor blades and the tapped air passes into the ditch, cooling the hub along the ditch, and then flows radially outwardly towards the gap.

In another embodiment according to any of the previous embodiments, the non-contact seal has a plurality of circumferentially spaced shoes biased radially toward the sacrificial piece.

In another embodiment according to any of the previous embodiments, air feed holes are included to tap air from a radially mid span of the compressor section through the housing, and to pass along the hub to resist flow of air radially inward of a gap between the last row of compressor blades and the housing from a radially inner, hotter location along the compressor blades.

In another embodiment according to any of the previous embodiments, the tapped air is tapped through the compressor exit guide vane.

In another embodiment according to any of the previous embodiments, the tapped air also passes through a controlled leakage path between the non-contact seal and the sacrificial piece to pass into a chamber downstream and towards a turbine section.

In another embodiment according to any of the previous embodiments, wherein there is a ditch in the hub downstream of the last row of compressor blades and the tapped air passes into the ditch, cooling the hub along the ditch, and then flowing radially outwardly towards the gap.

In another embodiment according to any of the previous embodiments, air feed holes are included to tap air from a radially mid span of the compressor section through the housing, and to pass along the hub to resist flow of air into a gap between the last row of compressor blades and the housing from a radially inner, hotter location along the compressor blades.

In another embodiment according to any of the previous embodiments, the tapped air is tapped through the compressor exit guide vane.

In another embodiment according to any of the previous embodiments, at least some of the air feed holes are tapped from an upstream end of compressor exit guide vane.

In another embodiment according to any of the previous embodiments, at least some of the air feed holes are tapped from a downstream end of the compressor exit guide vane.

These and other features may be best understood from the following drawings and specification.

### BRIEF DESCRIPTION OF THE DRAWINGS

FIG. 1 shows a schematic view of a gas turbine engine.

FIG. 2 shows an arrangement at a downstream end of a high pressure compressor.

FIG. 3 shows an optional detail that may be incorporated into the downstream end of the compressor.

FIG. 4 shows a seal embodiment.

FIG. 5 shows a schematic view of the FIG. 4 seal.

### DETAILED DESCRIPTION

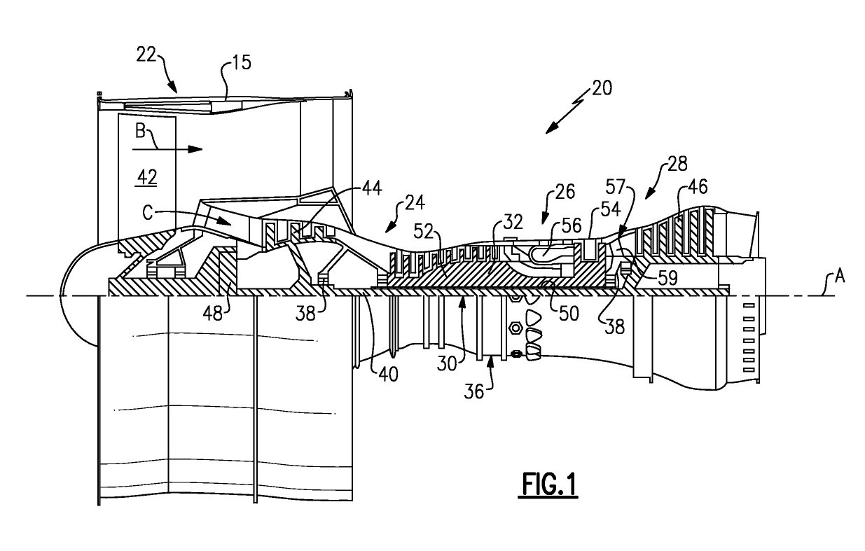

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

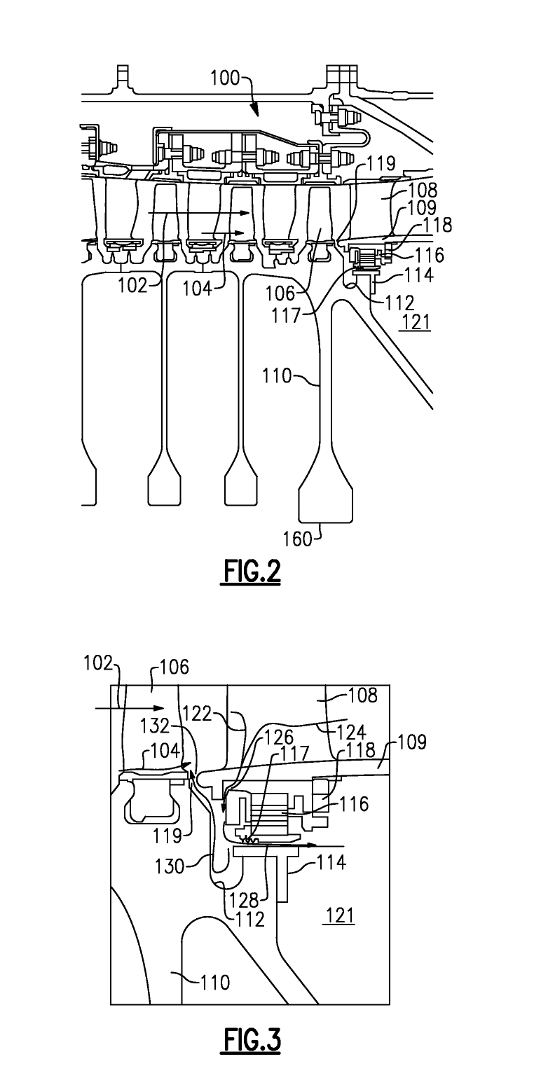

FIG. 2 shows a high pressure compressor section 100. Airflow 102 at a radial midpoint of the compressor section is shown along with an airflow 104, which is at a radially inner location. As known, there is a temperature differential between airflows 102 and 104, with airflow 102 being generally cooler than airflow 104.

A last stage compressor blade row 106 is shown adjacent to an exit guide vane row 108. As shown, exit guide vane 108 is mounted on a housing member 109. A hub 110 rotates with the blade row 106. Hub 110 is a challenging location due to the high temperature induced stresses mentioned above. As shown, there is a ditch 112 at a downstream end of the hub 110. A sacrificial seal piece 114 may be mounted at a location downstream of the ditch 112. A non-contact seal 116 is mounted radially inward of the housing 109 to seal between the hub 110 and the housing 109. As shown, this non-contact seal 116 may have knife-edge seal portions 117. A snap ring 118 may mount the seal 116 on the housing 109. The member 114 is sacrificial and may be removed once worn. Alternatively, a coating may be placed on the hub 110 at this location as the sacrificial seal piece.

Of course, the seal 116 could rotate with the hub 110 and the sacrificial piece could be mounted on the housing 109. The seal 116 limits the flow of the hot gas 104 to a chamber 121 where it will heat the hub 110 and eventually lead downstream towards the turbine section.

FIG. 3 shows an alternative embodiment wherein some of the mid span airflow 102 is tapped through cooling holes 122 and/or 124 in the exit guide vane 108. Cooling hole 122 is at an upstream end of the exit guide vane and hole 124 is at a downstream end. The airflow flows inwardly, as shown at 126, and through a gap 128 into the chamber 121.

The airflow also flows, as shown at 130 to cool the ditch 112 and hub 110, and then upwardly, as shown at 132, into a gap 119 to resist the flow of the hotter air 104 from moving downwardly towards the ditch 112. This arrangement significantly cools the temperature of air that the hub 110 is exposed to along the ditch 112 and radially outwardly.

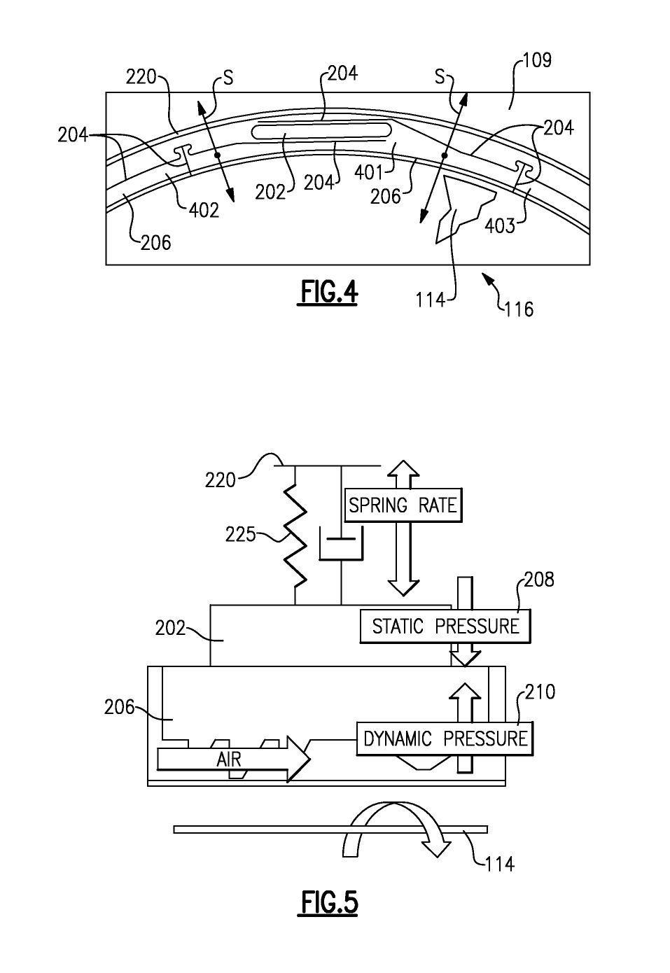

As shown in FIG. 4, the seal 116 provides a spring force, shown schematically at S, biases a seal shoe 206 toward a neutral position. The housing 109 is shown mounting seal 116. The spring force is created as the shoe 206 is otherwise biased toward and away from the sacrificial piece 114. That is, there is a natural position of the shoe 206 relative to a carrier 220, and, as it moves away from this position in either direction, it creates an opposing bias force.

The illustrated seal may be a HALO™ seal available from ATGI, Advanced Technologies Group, Inc. of Stuart, Fla. The HALO™ seal 116 as shown in FIGS. 4 and 5 has inner shoes 206, and an outer carrier 220. The outer carrier 220 and the shoes 206 are generally formed from a single piece of metal, and are cut as shown at 204 such that the combined seal 116 is formed into segments. As shown, the cuts 204 actually provide a gap that allow arms associated with the seal to provide a spring force, as mentioned below. The gaps provided by the cut 204 are relatively small, for example less than 0.050″ (0.127 cm). The spring force S is shown schematically. As shown in FIG. 4, there are portions of three adjacent segments 401, 402, 403, which come together to form the overall seal 116. A cavity 202 receives pressurized air.

As shown in FIG. 5, a spring force, shown schematically at 225, biases the seal shoe 206 toward a neutral position. The spring force is created as the shoe 206 is otherwise biased toward and away from the rotating component 114. That is, there is a natural position of the shoe 206 relative to the carrier 220, and, as it moves away from this position in either direction, it creates an opposing bias force.

As can be appreciated from FIG. 4, taken into combination with FIG. 5, air is injected into the cavity 202, and biases the shoe 206 toward the sacrificial piece 114. Thus, there is a static pressure force 208 forcing the shoe 206 toward the rotor, and an opposing spring force 225 tending to restore the shoe to a neutral position. In addition, a dynamic pressure 210, whose magnitude depends on the proximity of the shoe to the rotor, forces the shoe away from the rotor.

These three forces come into equilibrium to center the shoe at a desired location relative to the rotor such that any disturbance to the system will tend to redistribute the forces in a manner that works to restore the shoe to the same material position as prior to the disturbance. In this way, it is self-adjusting, and without need of any external control. These types of self-adjusting non-contacting seals effectively minimize both axi-symmetric (all shoes of the ring behave in the same manner) and non-axisymmetric (each shoe of the ring behaves independent of its neighbors) clearances. As such, these seals achieve very low leakage rates which enable the provision of thrust balance cavities in an effective and efficient manner.

While the seals are shown on the static housing, they may also rotate with the rotor and seal on static housing. While one particular seal is shown, other types of seals may be utilized.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine compressor section comprising:
a hub carrying a last row of compressor blades; and
a compressor exit guide vane downstream of said last row of compressor blades, a housing radially inward of said compressor exit guide vane, a non-contact seal being positioned on one of said housing and said hub.

2. The gas turbine engine compressor section as set forth in claim 1, wherein a sacrificial piece is located on the other of said housing and said hub.

3. The gas turbine engine compressor section as set forth in claim 2, wherein said sacrificial piece is removable from said one of said housing and said hub.

4. The gas turbine engine compressor section as set forth in claim 2, wherein said non-contact seal is mounted on said housing and seals on a radially outer surface of said sacrificial piece.

5. The gas turbine engine compressor section as set forth in claim 4, wherein said non-contact seal has a plurality of circumferentially spaced shoes biased radially toward said sacrificial piece.

6. The gas turbine engine compressor section as set forth in claim 5, wherein air feed holes are included to tap air from a radially mid span of said compressor section through said housing, and to pass along said hub to resist flow of air radially inward of a gap between said last row of compressor blades and said housing from a radially inner, hotter location along said compressor blades.

7. The gas turbine engine compressor section as set forth in claim 6, wherein said tapped air is tapped through said compressor exit guide vane.

8. The gas turbine engine compressor section as set forth in claim 7, wherein at least some of said air feed holes are tapped from an upstream end of compressor exit guide vane.

9. The gas turbine engine compressor section as set forth in claim 7, wherein at least some of said air feed holes are tapped from a downstream end of said compressor exit guide vane.

10. The gas turbine engine compressor section as set forth in claim 7, wherein said tapped air also passing through a controlled leakage path between said non-contact seal and said sacrificial piece to pass into a chamber downstream and towards a turbine section.

11. The gas turbine engine compressor section as set forth in claim 7, wherein there is a ditch in said hub downstream of said last row of compressor blades and said tapped air passing into said ditch, cooling said hub along said ditch, and then flowing radially outwardly towards said gap.

12. The gas turbine engine compressor section as set forth in claim 1, wherein said non-contact seal has a plurality of circumferentially spaced shoes biased radially toward said sacrificial piece.

13. The gas turbine engine compressor section as set forth in claim 12, wherein air feed holes are included to tap air from a radially mid span of said compressor section through said housing, and to pass along said hub to resist flow of air radially inward of a gap between said last row of compressor blades and said housing from a radially inner, hotter location along said compressor blades.

14. The gas turbine engine compressor section as set forth in claim 13, wherein said tapped air is tapped through said compressor exit guide vane.

15. The gas turbine engine compressor section as set forth in claim 14, wherein said tapped air also passing through a controlled leakage path between said non-contact seal and said sacrificial piece to pass into a chamber downstream and towards a turbine section.

16. The gas turbine engine compressor section as set forth in claim 15, wherein there is a ditch in said hub downstream of said last row of compressor blades and said tapped air passing into said ditch, cooling said hub along said ditch, and then flowing radially outwardly towards said gap.

17. The gas turbine engine compressor section as set forth in claim 1, wherein air feed holes are included to tap air from a radially mid span of said compressor section through said housing, and to pass along said hub to resist flow of air into a gap between said last row of compressor blades and said housing from a radially inner, hotter location along said compressor blades.

18. The gas turbine engine compressor section as set forth in claim 17, wherein said tapped air is tapped through said compressor exit guide vane.

19. The gas turbine engine compressor section as set forth in claim 18, wherein at least some of said air feed holes are tapped from an upstream end of compressor exit guide vane.

20. The gas turbine engine compressor section as set forth in claim 18, wherein at least some of said air feed holes are tapped from a downstream end of said compressor exit guide vane.
